(19) United States
(12) Patent Application Publication
(10) Pub. No.: US 2015/0217238 A1
(43) Pub. Date: Aug. 6, 2015

(54) REINFORCED MEMBRANES FOR PRODUCING OSMOTIC POWER IN PRESSURE RETARDED OSMOSIS

(71) Applicant: Nanyang Technological University, Singapore (SG)

(72) Inventors: Chuyang Tang, Singapore (SG); Qianhong She, Singapore (SG); Ning Ma, Singapore (SG); Jing Wei, Singapore (SG); Siang Tze Victor Sim, Singapore (SG); Anthony Gordon Fane, Singapore (SG)

(21) Appl. No.: 14/421,808

(22) PCT Filed: Aug. 15, 2013
(86) PCT No.: PCT/SG2013/000350

§ 371 Date: Feb. 13, 2015

Related U.S. Application Data
(60) Provisional application No. 61/683,475, filed on Aug. 15, 2012.

(51) Int. Cl. B01D 69/10; B01D 61/00; B01D 69/12

(52) U.S. Cl. CPC B01D 69/10; B01D 69/12; B01D 61/002; B01D 2325/40

(57) ABSTRACT

There is provided a reinforced membrane for producing osmotic power in pressure retarded osmosis. The membrane includes a base layer with mechanical reinforcement; and a porous substrate layer adjacent to the base layer, the porous substrate layer being macrovoid-free. The membrane may further include a rejection layer adjacent to the base layer.

### FIELD OF INVENTION

The present invention relates to a reinforced membrane used when mixing liquid streams.

### BACKGROUND

The mixing of two liquid streams with salinity gradient releases clean and renewable energy that is called salinity gradient energy or osmotic power. The available renewable osmotic power in nature is estimated to be in an order of 2000 TWh per year globally when released from the mixing of seawater and river water in estuaries [1]. In industry, tons of waste brine (such as seawater desalination brine) carries huge osmotic potential. A lot of osmotic power can also be produced by mixing this waste brine with a low salinity aqueous liquid.

Pressure retarded osmosis (PRO) is one of the technologies employed to harvest renewable osmotic power [1, 2]. In a PRO process, a low salinity feed solution and a pressurized high salinity draw solution are placed on opposite sides of a semi-permeable membrane. Osmotic power is produced when water in the feed solution permeates through the membrane and mixes with the pressurized draw solution [3]. The osmotic power, which is equal to the product of the applied pressure and water permeation rate, can be further harvested in the form of electricity by depressurizing the permeate-enhanced draw solution through a hydroturbine [3, 4]. Pioneered by Loeb and co-workers [5], PRO has received increasing interest from researchers and industry players in recent years [6-13]. In late 2009, a Norwegian energy company Statkraft started up the world's first osmotic power plant. According to their projection, PRO will become economically competitive when its power density reaches 5 W/m².

The PRO membrane is the key factor affecting the PRO performance (both water flux and power density). However, to date, there is no commercial forward osmosis (FO) membrane available for PRO, which compromises large-scale commercialization of PRO technology. The most apparent drawback of the current membranes used for PRO is severe membrane deformation at high applied pressures [6, 7, 10]. For PRO applications, the optimum applied pressure is ˜50% of the osmotic pressure of the draw solution. Commonly targeted draw solutions for PRO applications include seawater (osmotic pressure ˜25 bar), desalination brine (osmotic pressure ˜50 bar), and other industrial brines. Thus, the optimum applied pressures are ˜12.5 bar when using seawater as draw solution and ˜25 bar when using desalination brine as draw solution. Even higher applied pressure can be expected when using more concentrated industrial brines. Under PRO operation, the membrane area between the feed spacer strands is unsupported and can deform at high applied pressures provided the membrane is lacking in sufficient mechanical strength [6, 7]. Severe membrane deformation can result in adverse impacts on PRO performance and PRO operation. First, the tensile stress developed at the membrane can stretch the selective rejection layer when the membrane deforms, and thus the membrane separation parameters will deteriorate in terms of the increase of membrane solute permeability and the decrease of membrane selectivity [6, 7], which is reflected in the sharp increase in the rate of reverse solute diffusion at elevated applied pressures [6]. Severe reverse solute diffusion can enhance the internal concentration polarization (ICP) and hence decrease the water flux and power density under PRO operation [6]. Second, the deformed membrane at high applied pressure can restrict or block the feed flow channel, which requires higher pressure applied in the feed side to maintain the feed flow and this increases the energy input for PRO operation [6, 7].

Current high performance FO membranes are unsuitable for PRO application because of their low mechanical stability at high applied pressures and resultant severe membrane deformation. For example, when the commercial FO membranes were tested under PRO operation at high applied pressures, severe membrane deformation resulted in much lower experimental water fluxes compared to theoretical predictions [6, 7]. Despite reduced membrane deformation for self-supported hollow fiber membranes, its low mechanical stability only allows it to be operated at a maximum pressure of about 9 bar [8]. A low operation pressure for PRO can reduce its ability to achieve a higher power density at higher applied pressure (since the applied pressure for a theoretical peak power density is approximately half that of the osmotic pressure difference) and may also reduce the energy conversion efficiency at the post stage for osmotic power recovery. However, commercially available reverse osmosis (RO) membranes have strong mechanical strength and can be operated at very high pressures (up to 1000 psi). Unfortunately, early studies observed extremely low water fluxes and power density due to the severe ICP caused by the large structure parameters in their support layers [5, 14].

An ideal PRO membrane should incorporate the characteristics of both RO membranes and FO membranes. First, it should have strong mechanical strength to avoid severe membrane deformation at high applied pressures. Second, it should have a dense selective rejection layer with high water permeability and low solute permeability to improve the water transport and reduce the reverse solute diffusion, and a support layer with a small structure parameter to minimize the ICP.

### SUMMARY

There is provided a reinforced membrane for producing osmotic power in pressure retarded osmosis. The membrane includes a base layer with mechanical reinforcement; and a porous substrate layer adjacent to the base layer, the porous substrate layer being macrovoid-free. The membrane may further include a rejection layer adjacent to the base layer. The mechanical reinforcement may be embedded in the porous substrate layer.

Preferably, the rejection layer is formed in a manner such as, for example, interfacial polymerization, phase inversion, chemical modification, surface coating and so forth. It is preferable that the monomers used in forming the rejection layer via interfacial polymerization are selected from, for example, polyfunctional amines for aqueous phase, polyfunctional acyl chlorides for organic phase, polysulfonylchloride for organic phase and the like. It is preferable that water is used as solvent for the aqueous phase and hydrocarbon solvents are used as a solvent for the organic phase.

Preferably, macromolecule organics, small molecule organics and surfactants are added to modify the rejection layer in at least one manner such as, for example, increasing miscibility of two immiscible phases, neutralizing byproducts during interfacial polymerization, modifying properties of the rejection layer and so forth.

It is preferable that the mechanical reinforcement is at least one selected from, for example, fabric reinforcement, wire-mesh reinforcement, tensile reinforcement, any combination of the aforementioned and so forth. The mechanical reinforcement may be either a single layer structure or a multi layer structure. A plurality of layers are laid on each other at a pre-determined angle in the multi layer structure, the pre-determined angle being, for example, 15°, 30°, 45°, 60° and 75°. It is advantageous that the multi layer structure enables uniform and isotropic transfer of mechanical force in the structure. In addition, the multi layer structure may be fabricated using a technique selected from, for example, weaving, knitting, wrapping, binding reinforcing bars, any combination of the aforementioned and so forth.

It is advantageous that the substrate layer is configured to provide a surface to form the rejection layer and to provide mechanical strength to the rejection layer. Preferably, the substrate layer is formed from polymeric materials selected from a group consisting of: polysulfone (PSf), polyethersulfone (PES), polyacrylonitrile (PAN), polyarylsulfone (PASf), poly(vinyl butyral) (PVB), derivatives of the aforementioned, and cellulose esters. It is also preferable that the substrate layer includes pores with pore size between 0.2 to 1.5 μm, and has thickness of between 100 to 300 μm.

### DESCRIPTION OF FIGURES

In order that the present invention may be fully understood and readily put into practical effect, there shall now be described by way of non-limitative example only preferred embodiments of the present invention, the description being with reference to the accompanying illustrative figures.

FIGS. 1(a)-(e) show SEM micrographs of a reinforced PRO membrane of the present invention.

FIGS. 2(a)-(b) show microscopic images of multi-layered mechanical reinforcement for the membrane of FIG. 1.

FIG. 3 shows a PRO setup for testing the membrane of FIG. 1.

FIG. 4 shows a table of synthesis parameters for producing the membrane of FIG. 1.

FIG. 5 shows a parameter comparison table between the membrane of FIG. 1 and a CTA-FO membrane.

FIG. 6 shows a table of test results for the membrane of FIG. 1 using the setup of FIG. 3.

FIG. 7 shows a table of test results for the CTA-FO membrane of FIG. 5 using the setup of FIG. 3.

FIG. 8 shows a schematic layer view of the membrane of FIG. 1.

### DESCRIPTION OF PREFERRED EMBODIMENTS

The present invention provides a PRO membrane with strong mechanical strength and high power density. The membrane is used for producing osmotic power using PRO. A mechanical reinforcement with strong mechanical strength and high porosity is embedded into a macrovoid-free (i.e. free of large pores) substrate layer to support the whole membrane. A selective rejection layer is formed on the top of the middle substrate layer.

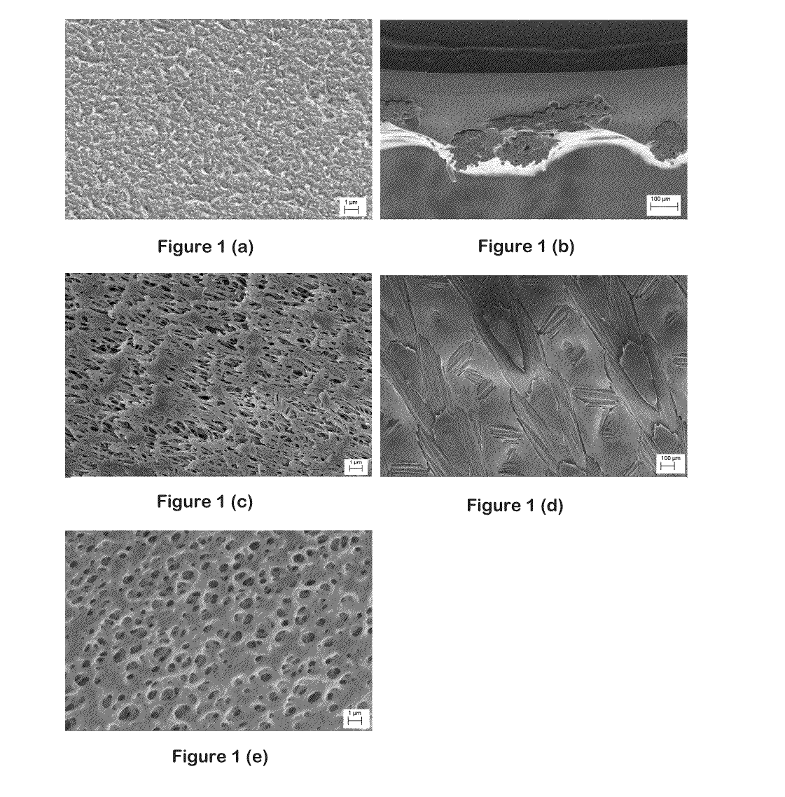

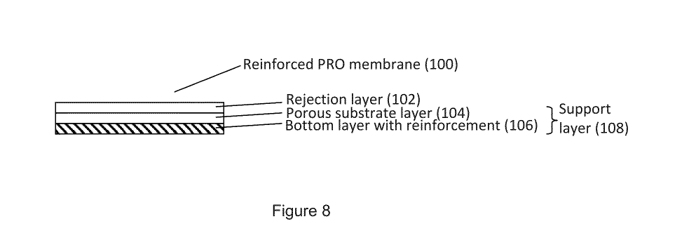

There is provided a reinforced PRO membrane (100) as shown in FIGS. 1 and 8. The membrane (100) includes a mechanical reinforcement at a bottom layer (106), a porous substrate layer (104) in the middle, and an ultra-thin/dense rejection layer (102) at a top surface of the substrate layer. A support layer (108) comprises the porous substrate layer (104) and the mechanical reinforcement (106). Incorporating the mechanical reinforcement (106) within the porous substrate layer (104) is critical in preventing the membrane (100) from undergoing excessive deformation and in maintaining desirable characteristics of the membrane (100) at high applied pressures during PRO applications.

The mechanical reinforcement is for maintaining mechanical stability of the whole membrane (100). The mechanical reinforcement is incorporated into a base at a bottom (106) of the membrane (100) and is partially or completely embedded in the porous substrate layer (104) in the middle to support the whole membrane (100) structure against the applied hydraulic pressures to prevent membrane deformation. The mechanical reinforcement is non-elastic and has high mechanical strength. The mechanical reinforcement is selected from, for example, fabric reinforcement, wire-mesh reinforcement, tensile reinforcement, any combination of the aforementioned and so forth. The mechanical reinforcement may be in a single-layer structure or multi-layered structure. The multi-layered structure is preferable as it is more suitable for resisting tensile stress developed at applied pressures. For the multi-layered structures, the plurality of layers are laid on each other at pre-determined angles, such as, for example, 15°, 30°, 45°, 60° or 75° relative to an adjacent layer.

The multi-layered reinforcement overlay at specific angles ensures uniform and isotropic transfer of mechanical force in the reinforcement. The mechanical reinforcement is able to withstand tensile forces at any direction (e.g., diagonal stretch). The mechanical reinforcement is carried out using a technique of, for example, weaving, knitting, wrapping, binding the reinforcing bars (mechanically, thermally or chemically), any combination of the aforementioned and so forth. Knitting technique is preferred as it enables high mechanical strength and a well-controlled multi-layered structure. Each reinforcement bar of the mechanical reinforcement is a single high-strength fiber (or monofilament), a bundle of high-strength fibers (or multifilament), or any combination of the aforementioned. The materials for mechanical reinforcement are selected from, for example, polyester, polypropylene, acrylics, nylon, any combination of the aforementioned and so forth. The thickness of the mechanical reinforcement is from 30 μm to 250 μm, while the porosity of the mesh fabric is greater than 50%.

The porous substrate layer (104) is cast on the mechanical reinforcement by a phase inversion method. The porous substrate layer (104) serves a first purpose of providing a substrate for forming a thin and dense selective rejection layer at its top surface, and a second purpose of providing mechanical strength to a top surface of the selective rejection layer to avoid stretching of the rejection layer due to tensile stress during the membrane deformation at high applied pressures. The porous substrate layer (104) is cast on the mechanical reinforcement that is smoothly attached on a glass plate before casting. The casting solution for the porous substrate layer (104) is prepared by dissolving PSf beads (18.0 wt. %) and PVP (10.0 wt. %) in NMP at 70° C. until homogeneous and transparent. The PVP is added to adjust the viscosity of the casting solution and hydrophilicity of the porous substrate layer (104). The viscosity of the casting solution should be high enough so that the porous substrate layer (104) can be effectively attached on the mechanical reinforcement without leaking through the reinforcement layer or delaminating from the reinforcement layer (106). The casting solution is then cooled down to room temperature and degassed statically in the same container. The casting solution is spread directly onto the mechanical reinforcement on the glass plate. The glass plate with the mechanical reinforcement and whole composite is then immediately immersed in a coagulant bath containing room temperature water for at least 5 min to finish the phase inversion. After the phase inversion, the mechanical reinforcement is partially or completely embedded into the porous substrate layer (104). The resultant porous substrate layer (104) is free of large pores, with the pore size between 0.2 to 1.5 μm. The resultant substrate layer (104) has a thickness of between 100 to 300 μm.

As such, the resultant porous substrate layer (104) of the PRO membrane (100) is free of large pores so that mechanical stability of the membrane is not compromised. This is contrary to typical FO membrane designs where continuous large pores are desired features for improved mass transfer inside the substrate. In PRO, however, due to the importance of membrane mechanical stability, a presence of large pores which weaken the membrane mechanical stability should be eliminated. Consequently, the resultant pore size of the porous substrate layer (104) is smaller than ˜5 μm.

The materials used for forming the substrate are selected from polymeric materials such as, for example, polysulfone (PSf), polyethersulfone (PES), polyacrylonitrile (PAN), polyarylsulfone (PASf), poly(vinyl butyral) (PVB), derivatives of the aforementioned, cellulose esters, and so forth. The concentration in polymer solution is between 10.0 to 25.0 wt. %, preferably 15.0 to 20.0 wt. %. Organic solvents are used to dissolve the polymers, such as, for example, 1-methyl-2-pyrrolidinone (NMP), dimethyl-acetamide (DMAc), dimethyl formamide (DMF), any combination of the aforementioned, and so forth. Macromolecule organics, small molecule organic/inorganic salts (such as, for example, polyvinyl pyrrolidone (PVP), and polyethylene glycol (PEG), acetone, isopropanol, ethanol, lithium chloride (LiCl), and the like), act as additives to adjust at least one of: polymer solution viscosity, membrane porosity, and hydrophobicity-hydrophilicity, of which concentration in polymer solution is between 0.1 to 20.0 wt. %, preferably 0.2 to 15.0 wt. %.

The ultra-thin/dense rejection layer (102) of the PRO membrane (100) is formed either by interfacial polymerization on the top of the porous substrate layer (104) or by phase inversion during the formation of the porous substrate layer (104) in the case of one-step formed integral asymmetric membranes. Other approaches of forming the rejection layer (102) such as, for example, chemical modification, surface coating, and the like are applicable as well. The formation of the rejection layer (102) is not limited to use of the aforementioned approaches.

When the rejection layer (102) is formed by phase inversion, the rejection layer (102) is made of the same polymer as that of the porous substrate layer (104). The monomers used in forming the rejection layer (102) via interfacial polymerization are selected from, for example, polyfunctional amines (such as m-phenylenediamine (MPD), o-phenylenediamine (OPD), piperazine, etc.) for aqueous phase, and polyfunctional acyl chlorides or polysulfonylchloride (such as trimesoyl chloride (TMC), 1, 5-naphthalene-bisulfonyl chloride, etc.) for organic phase. Water is used as solvent for aqueous phase. Hydrocarbon solvents (such as, for example, n-hexane, cyclohexane, Isopar serials, any combination of the aforementioned and the like) is used as a solvent for organic phase. Macromolecule organics, small molecule organics and surfactants, such as dimethyl sulfoxide (DMSO), ε-caprolactam (CL), triethylamine (TEA), camphorsulfonic acid (CSA), sodium dodecyl sulfate (SDS) are added to modify the rejection layer (102), such as, increase the miscibility of two immiscible phases, neutralize byproducts during interfacial polymerization, modify the properties of resultant rejection layer in terms of the permeability, selectivity, salt rejection, hydrophilicity, roughness, surface charge, and so forth.

During the preparation of polymer solution for casting the porous substrate layer (104), certain amounts of polymer and additives are dissolved in organic solvent in a sealed container at between room temperature to 90° C., preferably between 50° C. to 70° C., until homogenously mixed. The casting solution is subsequently degassed statically after cooling down to room temperature. The casting solution is then directly cast with certain thickness onto a specific mechanical reinforcement. The whole composite (the casted solution together with the mechanical reinforcement) is then immersed into a coagulation water bath smoothly. After the porous substrate layer (104) is formed by phase inversion, excess solvent and additives are removed by washing in the water bath before interfacial polymerization.

During the interfacial polymerization, a pre-formed membrane substrate is first contacted with aqueous amine solution for between 1 to 1200 s, preferably between 30 to 600 s. This is followed by removal of the excess aqueous solution from the surface, and is then contacted with well dispersed organic solution of polyfunctional acyl chlorides or polysulfonylchloride for between 1 to 600 s, preferably between 10 to 300 s immediately. After formation of the rejection layer (102), the membrane is rinsed thoroughly by water, and stored in de-ionised water before use. During interfacial polymerization, the aqueous phase is prepared by dissolving 1.5 wt. % 1, 3-phenylendiamine (MPD) in water, while the organic phase is prepared by dissolving 0.1 mg/ml 1, 3, 5-benzenetricarbonyl trichloride (TMC) in n-hexane. The preformed substrate is first soaked into MPD solution for 5 minutes, then the excess MPD solution is removed from the substrate surface by air-knife. The membrane is brought into contact with TMC solution for 1 minute. After the excess TMC solution is drained, the membrane is rinsed thoroughly using water, and stored in 20° C. de-ionized water before characterization.

The resulting PRO membrane (100) has an overall thickness of between 60 to 350 μm. The mechanical reinforcement is partially or completely embedded in the porous substrate layer (104). The cross section of the porous substrate layer (104) exhibits a sponge-like porous structure with a mean pore diameter of smaller than 5 μm. The top rejection layer (102) is ultra-thin with a thickness of less than 1 μm.

The reinforced PRO membrane (100) has a water permeability of higher than 2.0×10⁻¹² m/s-Pa, salt permeability lower than 3.0×10⁻⁷ m/s (testing condition: 10 mM NaCl solution as feed, trans-membrane pressure of 50 psi, 25° C.). In PRO testing, the reinforced membrane (100) is able to withstand a hydraulic pressure of above 400 psi (˜28 bar) without severe membrane deformation and reverse solute diffusion. In addition, the membrane (100) produced a peak power density above 5 W/m² when tested with 1 M NaCl draw solution and 10 mM NaCl feed solution.

In a preferred embodiment, the selected mechanical reinforcement of the resultant PRO membrane (100) is fabric reinforcement. The mechanical reinforcement has two major layers and is in a close knit design with the reinforcing bars running in a crosswise direction at one side (the first major layer) while the reinforcing bars running in a lengthwise pattern at the other side (the second major layer). The first major layer is comprised of two sub-layers that overlay each other in an angle of approximately 60°. Both of the two sub-layers of the first major layer were cross-linked with the second major layer. The mechanical reinforcement is unable to be stretched diagonally at any directions. Each reinforcing bar of the mechanical reinforcement is comprised of between 45 to 55 filaments. The mechanical reinforcement is made from polyester with a thickness of between 100 to 250 μm and a porosity of more than 50%. This multi-layered reinforcement provides substantial mechanical strength to support the whole membrane against high applied pressures. FIG. 1 shows the SEM micrographs of the reinforced PRO membrane (100) using a Zeiss Evo 50 Scanning Electron Microscope. FIG. 1(a) shows a surface of the rejection layer (102) that is formed via interfacial polymerization on a top surface of the porous substrate layer (104). FIG. 1(b) shows a cross-sectional view of the whole reinforced membrane (100). FIG. 8 is a simplified version of FIG. 1(b). FIG. 1(c) shows a cross-sectional view of the porous substrate layer (104) at a high magnification level. FIG. 1(d) shows a back surface of the reinforced membrane (100) at a low magnification level. Finally, FIG. 1(e) shows the back surface of the reinforced membrane (100) at a high magnification level.

Referring to FIGS. 1(b) and 1(d), it can be observed that the mechanical reinforcement is nearly completely embedded in the porous substrate layer (104) to support the whole membrane (100) against high applied pressures under PRO operation. Referring to FIGS. 1(c) and 1(e), it can be observed that the mean pore size of the porous substrate layer (104) is less than 1.5 μm. It can also be observed from FIG. 1(b) that the overall thickness of the reinforced PRO membrane (100) is 160 to 300 μm.

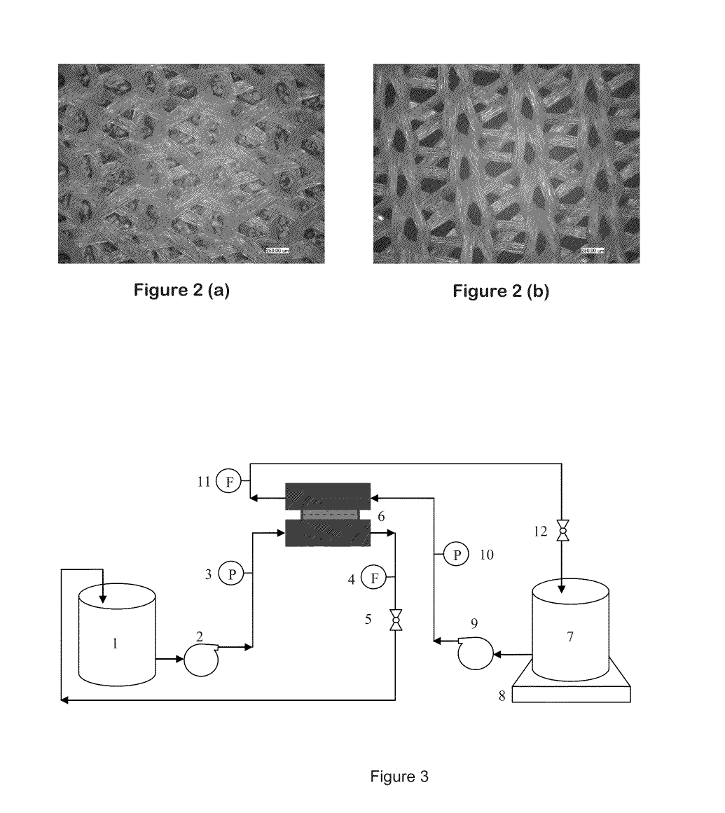

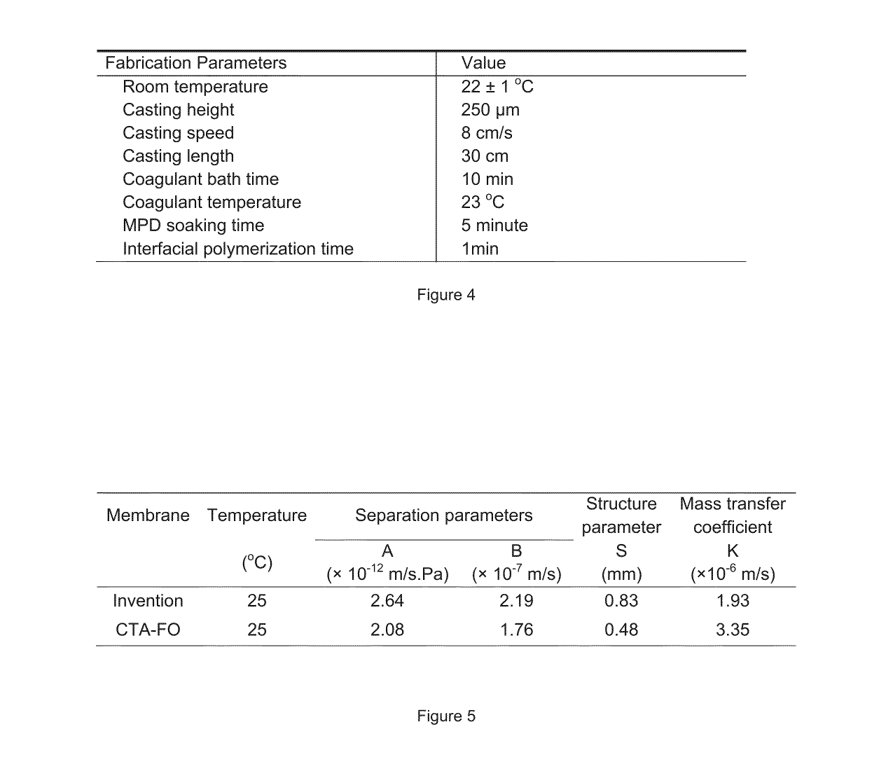

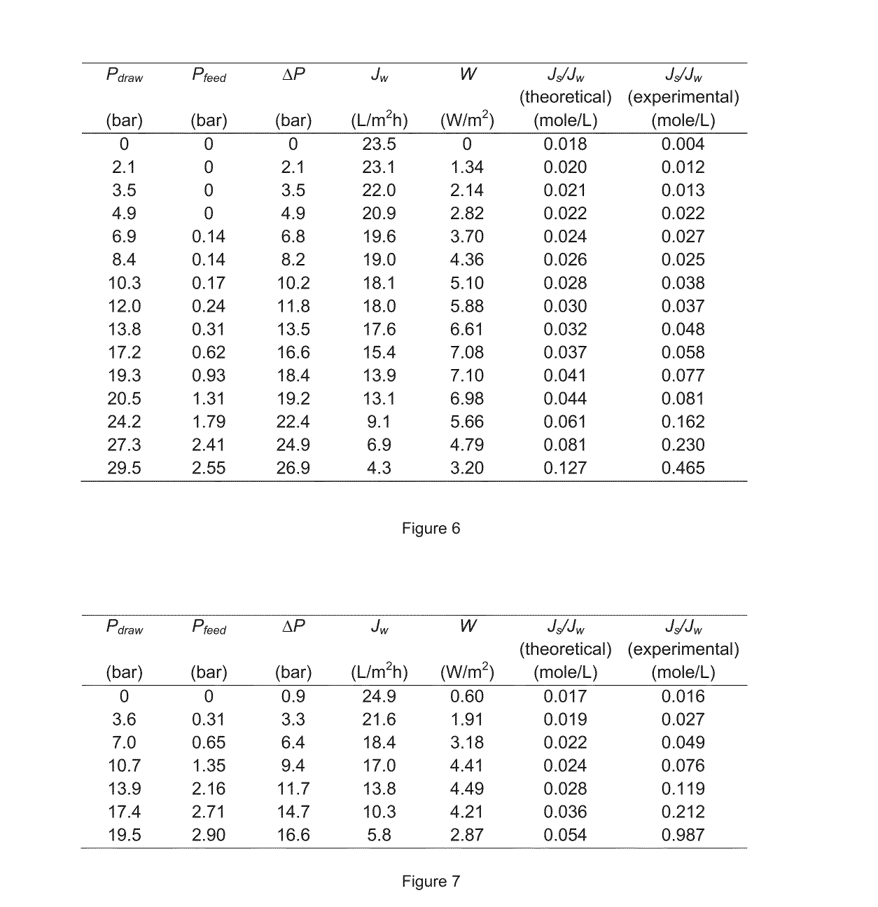

FIG. 2 shows microscopic images of the multi-layered mechanical reinforcement used as the membrane bottom layer (106). FIG. 2(a) shows a top surface of the mechanical reinforcement. There is shown a first major layer of the mechanical reinforcement, which is comprised of two sub-layers that overlay each other in an angle of approximately 60°. The reinforcing bars run in a crosswise direction. The porous substrate layer (104) is cast on this top surface. FIG. 2(b) shows a bottom surface of the mechanical reinforcement, that is, the second layer of the mechanical reinforcement. The reinforcing bars run in a lengthwise pattern. It should be appreciated that FIGS. 2(a) and 2(b) show the first major layer and the second major layer prior to being cross-linked with each other to form the mechanical reinforcement. The multi-layered structure of the mechanical reinforcement as the membrane bottom support layer (106) enable the membrane (100) to have significant mechanical strength to withstand applied pressures on the membrane surface and resist tensile stress along the membrane surface.

Referring to FIG. 3, there is shown a PRO setup for testing performance of PRO membranes. The PRO membrane is placed in the center of the PRO cell (6). Identical net-type spacers (spacer thickness of approximately 1.55 mm, filament diameter of approximately 0.90 mm, opening size of approximately 0.60 mm, opening ratio of approximately 0.55) are placed in the draw solution channel and feed solution channel of the PRO cell (6) respectively for improved membrane support and reduced external concentration polarization (ECP). Draw solution from draw solution tank (1) is recirculated by a high pressure pump (2), while feed solution from feed solution tank (7) is recirculated by a low pressure pump (9). The pressure in the draw solution is set by a back pressure regulator located downstream of the PRO cell (6), and the pressure reading is monitored by a first pressure gauge (3). The back pressure in feed solution is also monitored with a second pressure gauge (10) to predict an extent of membrane deformation. The effective applied hydraulic pressure on the PRO membrane equals the difference of pressure recorded in draw solution and that in feed solution. Water flux is determined by measuring the weight changes of the feed solution tank (7) on the digital balance (8) at pre-determined time intervals. Reverse solute flux is determined by calculating the changes of total amount of salt in the feed solution with time. The power density is evaluated by the product of water flux and effective applied hydraulic pressure. The testing conditions include: 1 M NaCl as draw solution, 10 mM NaCl as feed solution, cross-flow rate 0.8 L/min, temperature 25° C., and membrane selective rejection layer facing the draw solution (AL-DS).

Table 1 shows general parameters for synthesis of reinforced TFC flat-sheet PRO membranes. The fabrication parameters include, for example, room temperature, casting height, casting speed, casting length, coagulant bath time, coagulant temperature, MPD soaking time, interfacial polymerization time and the like.

Table 2 shows a comparison of membrane separation parameters and structure parameters of a reinforced PRO membrane of the present invention and a commercial CTA-FO membrane. It should be appreciated that “A” represents water permeability while “B” represents salt permeability.

Table 3 shows back pressure in feed side (P_{feed}), water flux (J_{w}), power density (W) and specific reverse solute flux (Jₛ/J_{w}) respectively at different applied hydraulic pressures in draw solution (P_{draw}) for the reinforced PRO membrane of the present invention when tested using the setup of FIG. 3.

Table 4 shows the back pressure in feed side (P_{feed}), water flux (J_{w}), power density (W) and specific reverse solute flux (Jₛ/J_{w}) respectively at different applied hydraulic pressures in draw solution (P_{draw}) for the commercial CTA-FO membrane tested in PRO experiments.

It should be appreciated that results in Table 4 are for comparison with the results in Table 3 to denote differences of the reinforced PRO membrane (100) of the present invention and the commercial CTA-FO membrane.

The following modifications can be made to further improve performance parameters of the PRO membrane (100):

1. Chemical and physical pre-treatment and post-treatment of the membrane, such as reagent rinse and hot water cure (for example, de-ionized water, sodium hypochlorite, sodium metabisulfite, sodium bicarbonate, and so forth). These treatments are able to increase water permeability (“A”) and able to reduce the selectivity (“B/A”) of the membrane (100).

2. Incorporation of nanoparticles into the selective rejection layer and middle substrate layer to enhance its water permeability and reduce its solute permeability as well as enhance mechanical strength.

3. Fabrication of reinforced double-skinned PRO membrane by casting an additional selective rejection layer at the other side of the mesh fabric. This is for the prevention of membrane fouling.

4. Fabrication of reinforced hollow-fiber PRO membrane by embedding robust mesh into its substrate layer (104). This is to increase the strength of the membrane (100).

5. Using other methods to produce the thin selective rejection layer (102) (for example, layer by layer, deposition, crosslinking and so forth).

6. Optimization of the thickness and porosity of the support layer to provide adequate mechanical strength with reduced structural parameter, whereby structural parameter (“S”) is a parameter to characterize the membrane support layer (108). It is defined to be S=(thickness×tortuosity)/porosity. A smaller S value is desirable for FO and PRO membranes due to the reduced ICP.

Advantageously, the design of the membrane support layer structure (108) provides a reinforced PRO membrane (100) that is specifically developed to withstand the pressure needed for PRO applications. This is carried out by:

a. Casting a substrate free of large pores (macrovoids), preferably less than 5 μm in size; and

b. Embedding a mechanical reinforcement.

As clearly demonstrated in She et al [6], mesh fabric deforms significantly under high applied pressure, leading to the loss of rejection and feed channel blockage. It is appreciated that even though single-layered reinforcement and multi-layered reinforcement are usable, multi-layered reinforcement is preferred due to a better ability to resist the tensile forces.

The reinforced PRO membrane (100) can significantly minimise the extent of membrane deformation and reduce the increment of reverse solute diffusion at high applied pressures. The reinforced PRO membrane (100) demonstrates high power density that is desirable for PRO application. The reinforced PRO membrane (100) can withstand a hydraulic pressure above 400 psi (˜28 bar) and achieve a peak power density of 7.1 W/m² at the effective applied pressure of 18.4 bar when tested with 1 M NaCl draw solution and 10 mM NaCl feed solution. This enables the reinforced PRO membrane (100) to be operated at a variety of conditions for harvesting the renewable osmotic power.

The reinforced PRO membrane (100) relies on a multi-layered mechanical reinforcement that has strong mechanical strength and high porosity. This material is integrated into the membrane and can maintain the membrane stability and reduce the extent of deformation under PRO operation at high applied hydraulic pressures. In addition, the materials used for formation of each layer have very good chemical resistance, such as the polyamide in the top selective rejection layer (102) and polysulfone in the middle porous substrate layer (104). The concept can also be extended to single-layered reinforcement with reinforcing strands arranged at selected angles to allow effective and uniform transfer to tensile forces in the reinforcement.

Therefore, the invented membrane (100) can be commercially used for producing osmotic power in PRO processes when operated under a variety of conditions especially at high applied pressures. Applications include an osmotic power plant for producing electricity [3, 4, 11, 15], and in the desalination industry for both diluting the seawater/waste brine and harvesting the osmotic power from the waste brine [16, 17]. The membrane (100) is also crucial in the realization of a hybrid single or dual PRO and RO system being utilized for reduced energy consumption when producing desalinated water and easy disposal of brine to the ocean. It is advantageous as only simple mixing is required without capital intensive brine dispersal outfalls and/or additional seawater intakes. Moreover, the adverse environmental impact is also minimised.

Whilst there have been described in the foregoing description preferred embodiments of the present invention, it will be understood by those skilled in the technology concerned that many variations or modifications in details of design or construction may be made without departing from the present invention.

### REFERENCES

1. Achilli, A.; Childress, A. E., Pressure retarded osmosis: From the vision of Sidney Loeb to the first prototype installation—Review. Desalination 2010, 261, (3), 205-211.

2. Ramon, G. Z.; Feinberg, B. J.; Hoek, E. M. V., Membrane-based production of salinity-gradient power. Energy Environ. Sci. 2011, 4, (11), 4423-4434.

3. Loeb, S., Production of energy from concentrated brines by pressure retarded osmosis. I. Preliminary technical and economic correlations. J. Membr. Sci. 1976, 1, (1), 49-63.

4. Loeb, S., Large-scale power production by pressure-retarded osmosis, using river water and sea water passing through spiral modules. Desalination 2002, 143, (2), 115-122.

5. Loeb, S.; Van Hessen, F.; Shahaf, D., Production of energy from concentrated brines by pressure retarded osmosis. II. Experimental results and projected energy costs. J. Membr. Sci. 1976, 1, (3), 249-269.

6. She, Q.; Jin, X.; Tang, C. Y., Osmotic power production from salinity gradient resource by pressure retarded osmosis: Effects of operating conditions and reverse solute diffusion. J. Membr. Sci. 2012, 401-402, 262-273.

7. Kim, Y. C.; Elimelech, M., Adverse impact of feed channel spacers on the performance of pressure retarded osmosis. Environ. Sci. Technol. 2012, 46, (8), 4673-4681.

8. Chou, S.; Wang, R.; Shi, L.; She, Q.; Tang, C.; Fane, A. G., Thin-film composite hollow fiber membranes for pressure retarded osmosis (PRO) process with high power density. J. Membr. Sci. 2012, 389, 25-33.

9. Yip, N. Y.; Tiraferri, A.; Phillip, W. A.; Schiffman, J. D.; Hoover, L. A.; Kim, Y. C.; Elimelech, M., Thin-film composite pressure retarded osmosis membranes for sustainable power generation from salinity gradients. Environ. Sci. Technol. 2011, 45, (10), 4360-4369.

10. Xu, Y.; Peng, X.; Tang, C. Y.; Fu, Q. S.; Nie, S., Effect of draw solution concentration and operating conditions on forward osmosis and pressure retarded osmosis performance in a spiral wound module. J. Membr. Sci. 2010, 348, (1-2), 298-309.

11. Patel, S., Norway inaugurates osmotic power plant. Power 2010, 154, (2).

12. Thorsen, T.; Holt, T., The potential for power production from salinity gradients by pressure retarded osmosis. J. Membr. Sci. 2009, 335, (1-2), 103-110.

13. Achilli, A.; Cath, T. Y.; Childress, A. E., Power generation with pressure retarded osmosis: An experimental and theoretical investigation. J. Membr. Sci. 2009, 343, (1-2), 42-52.

14. Lee, K. L.; Baker, R. W.; Lonsdale, H. K., Membranes for power generation by pressure-retarded osmosis. J. Membr. Sci. 1981, 8, (2), 141-171.

15. Gerstandt, K.; Peinemann, K. V.; Skilhagen, S. E.; Thorsen, T.; Holt, T., Membrane processes in energy supply for an osmotic power plant. Desalination 2008, 224, (1-3), 64-70.

16. Hancock, N. T.; Black, N. D.; Cath, T. Y., A comparative life cycle assessment of hybrid osmotic dilution desalination and established seawater desalination and wastewater reclamation processes. Water Res. 2012, 46, (4), 1145-1154.

17. Saito, K.; Irie, M.; Zaitsu, S.; Sakai, H.; Hayashi, H.; Tanioka, A., Power generation with salinity gradient by pressure retarded osmosis using concentrated brine from SWRO system and treated sewage as pure water. Desalination and Water Treatment 2012, 41, (1-3), 114-121.

1. A reinforced membrane for producing osmotic power in pressure retarded osmosis, the membrane including:
a base layer with mechanical reinforcement, the mechanical reinforcement being at least one selected from a group consisting of: fabric reinforcement, wire-mesh reinforcement, and tensile reinforcement, the mechanical reinforcement having a multi layer structure wherein a plurality of layers are laid on each other at a pre-determined angle to enable uniform and isotropic transfer of mechanical force in the structure; and
a porous substrate layer adjacent to the base layer, the porous substrate layer being macrovoid-free.

2. The membrane of claim 1, further including a rejection layer adjacent to the base layer.

3. The membrane of claim 2, wherein the rejection layer is formed in a manner selected from a group consisting of: interfacial polymerization, phase inversion, chemical modification, and surface coating.

4. The membrane of claim 2, wherein monomers used in forming the rejection layer via interfacial polymerization are selected from a group consisting of: polyfunctional amines for aqueous phase, polyfunctional acyl chlorides for organic phase and polysulfonylchloride for organic phase.

5. The membrane of claim 4, wherein water is used as solvent for the aqueous phase and hydrocarbon solvents are used as a solvent for the organic phase.

6. The membrane of claim 5, wherein macromolecule organics, small molecule organics and surfactants are added to modify the rejection layer in at least one manner selected from a group consisting of: increasing miscibility of two immiscible phases, neutralizing byproducts during interfacial polymerization, and modifying properties of the rejection layer.

7. The membrane of claim 1, wherein the mechanical reinforcement is embedded in the porous substrate layer.

8-10. (canceled)

11. The membrane of claim 1, wherein the pre-determined angle is selected from a group consisting of: 15°, 30°, 45°, 60° and 75°.

12. (canceled)

13. The membrane of claim 1, wherein the multi layer structure is fabricated using a technique selected from a group consisting of: weaving, knitting, wrapping, binding reinforcing bars, and any combination of the aforementioned.

14. The membrane of claim 2, wherein the substrate layer is configured to provide a surface to form the rejection layer and to provide mechanical strength to the rejection layer.

15. The membrane of claim 14, wherein the substrate layer is formed from polymeric materials selected from a group consisting of: polysulfone (PSf), polyethersulfone (PES), polyacrylonitrile (PAN), polyarylsulfone (PASf), poly(vinyl butyral) (PVB), derivatives of the aforementioned, and cellulose esters.

16. The membrane of claim 14, wherein the substrate layer includes pores with pore size between 0.2 to 1.5 μm, and the substrate layer has thickness of between 100 to 300 μm.
